(19) United States
(12) Patent Application Publication
(10) Pub. No.: US 2013/0076999 A1
(43) Pub. Date: Mar. 28, 2013

(54) LIGHT SOURCE DEVICE, DISPLAY DEVICE AND ELECTRONIC APPARATUS

(71) Applicants: Masaru Minami, Kanagawa (JP); Mamoru Suzuki, Tokyo (JP)

(72) Inventors: Masaru Minami, Kanagawa (JP); Mamoru Suzuki, Tokyo (JP)

(73) Assignee: Sony Corporation, Tokyo (JP)

(21) Appl. No.: 13/608,083

(22) Filed: Sep. 10, 2012

(30) Foreign Application Priority Data
Sep. 28, 2011 (JP) 2011-211922
Nov. 10, 2011 (JP) 2011-246774

(51) Int. Cl. G02F 1/13357; F21V 9/14; F21V 8/00

(52) U.S. Cl. 349/15; 362/608; 362/19

(57) ABSTRACT

Provided is a light source device including a light guide panel which has a first inner reflecting surface and a second inner reflecting surface opposing each other, a first light source which irradiates first illuminating light from a lateral direction to the light guide panel, a second light source which is arranged opposite a side on which the second inner reflecting surface is formed on the light guiding panel, and which irradiates second illuminating light to the second inner reflecting surface, and an optical member which is arranged between the light guide panel and the second light source, and which reduces intensity of incident light, wherein a plurality of scattering areas are provided on the second inner reflecting surface which scatter and emit the first illuminating light from the first inner reflecting surface to outside of the light guide panel.

### BACKGROUND

The present disclosure relates to a light source device, display device and electronic apparatus that can enable stereoscopic vision by a parallax barrier method.

A stereoscopic display device of a parallax barrier method is known as a stereoscopic dimensional display method that can enable stereoscopic vision with the naked eyes without having to wear special glasses. This stereoscopic display device is arranged opposite a parallax barrier on a front surface (display surface side) of a two-dimensional display panel. A general structure of the parallax barrier includes, alternately in a horizontal direction, a shielding section which shields display image light from the two-dimensional display panel, and a striped opening section (slit section) which transmits the display image light.

In the parallax barrier method, stereoscopic vision is performed by displaying a parallax image for stereoscopic vision (in the case of two viewpoints, a viewpoint image for the right eye and a viewpoint image for the left eye) as a space division in the two-dimensional panel, and horizontally parallax separating this parallax image with a parallax barrier. In the case where an observer views a stereoscopic display device from a prescribed position and direction by appropriately setting a slit width or the like in the parallax barrier, the light of the different parallax images can separately enter the left and right eyes of the observer through the slit section.

Note that in the case where a transmission type liquid crystal display panel, for example, is used as the two-dimensional panel, a configuration which arranges a parallax barrier on a rear surface side of the two-dimensional display panel is possible (refer to FIG. 1 of JP Patent No. 3565391 and FIG. 3 of JP 2007-187823A). In this case, the parallax barrier is arranged between the transmission type liquid crystal display panel and a backlight.

### SUMMARY

However, in the stereoscopic display device of a parallax barrier method, since exclusive parts for a three-dimensional display may be necessary for the parallax barrier, there is the problem where a large number of parts and arrangement space may be necessary compared to a display device for a normal two-dimensional display.

It is desirable to provide a light source device, display device and electronic apparatus that can realize equivalent functions to those of a parallax barrier using a light guide panel.

According to an embodiment of the present disclosure, there is provided a light source device, including a light guide panel which has a first inner reflecting surface and a second inner reflecting surface opposing each other, a first light source which irradiates first illuminating light from a lateral direction to the light guide panel, a second light source which is arranged opposite the side on which the second inner reflecting surface is formed on the light guiding panel, and which irradiates second illuminating light to the second inner reflecting surface, and an optical member which is arranged between the light guide panel and the second light source, and which reduces the intensity of incident light. A plurality of scattering areas are provided on the second inner reflecting surface which scatter and emit the first illuminating light from the first inner reflecting surface to outside of the light guide panel.

The display device according to the present disclosure includes a display section which performs image display, and a light source device which emits light for image display to the display section, and this light source device is composed of the light source device of the present disclosure shown above.

The electronic apparatus according to the present disclosure includes the display device of the present disclosure shown above.

In the light source device, display device or electronic apparatus according to the present disclosure, first illuminating light is scattered from a first light source by scattering areas, and the first illuminating light is emitted from a first inner reflecting surface to outside of a light guide panel. In this way, a function as a parallax barrier can be provided in the light guide panel itself. That is, the scattering areas can equivalently function as a parallax barrier with an opening section (slit section). Here, for example, in the case where the first illuminating light is transmitted through the scattering areas and is reflected at the surface of the second light source, while the first illuminating light is considered to be emitted to outside of the light guide panel as unintentionally emitted light, this unintentionally emitted light may be reduced by providing an optical member, which reduces the intensity of incident light, between the light guide panel and the second light source.

According to the light source device, display device or electronic apparatus of the present disclosure, since scattering areas are provided in a second inner reflecting surface of the light guide panel, a function as a parallax barrier can be equivalently provided in the light guide panel itself. Further, since an optical member, which reduces the intensity of incident light, is provided between the light guide panel and the second light source, unintentionally emitted light reflected on the surface of the second light source can be reduced.

### BRIEF DESCRIPTION OF THE DRAWINGS

FIG. 1 is a cross-sectional view showing a configuration example of the display device according to a first embodiment of the present disclosure with an emitting state of a light ray from a light source device, in the case where only a first light source is in an on (lighting) state;

FIG. 2 is a cross-sectional view showing a configuration example of the display device shown in FIG. 1 with an emitting state of a light ray from a light source device, in the case where only a second light source is in an on (lighting) state;

FIG. 3 is a cross-sectional view showing a configuration example of the display device shown in FIG. 1 with an emitting state of a light ray from a light source device, in the case where both a first light source and a second light source are in an on (lighting) state;

FIG. 4 is a cross-sectional view showing a modified example of the display device shown in FIG. 1;

FIG. 5 is a cross-sectional view showing the operation of a cutoff filter in the display device shown in FIG. 1;

FIG. 6A is a cross-sectional view showing a first configuration example of a light guide panel surface in the display device shown in FIG. 1;

FIG. 6B is an explanatory diagram schematically showing a scattering and reflecting state of a light ray at the light guide panel surface shown in FIG. 6A;

FIG. 7A is a cross-sectional view showing a second configuration example of a light guide panel surface in the display device shown in FIG. 1;

FIG. 7B is an explanatory diagram schematically showing a scattering and reflecting state of a light ray at the light guide panel surface shown in FIG. 7A;

FIG. 8A is a cross-sectional view showing a third configuration example of a light guide panel surface in the display device shown in FIG. 1;

FIG. 8B is an explanatory diagram schematically showing a scattering and reflecting state of a light ray at the light guide panel surface shown in FIG. 8A;

FIG. 9 is a plan view showing an example of a pixel structure of a display section;

FIG. 10(A) is a plan view showing an example of a corresponding relation between an allocation pattern and an arrangement pattern of the scattered areas, in the case where two viewpoint images are allocated, and (B) is a cross-sectional view of (A);

FIG. 11 is a cross-sectional view showing a configuration example of the display device according to a comparative example with an emitting state of a light ray from a light source device, in the case where only a first light source is in an on (lighting) state;

FIG. 12 is a cross-sectional view showing a configuration example of the display device according to a second embodiment of the present disclosure with an emitting state of a light ray from a light source device, in the case where only a first light source is in an on (lighting) state;

FIG. 13 is an explanatory diagram showing an example of a transmission state of second illuminating light, in the case where a polarizing panel is used as an optical member;

FIG. 14 is an explanatory diagram showing an example of a transmission state of second illuminating light, in the case where a cutoff filter is used as an optical member; and

FIG. 15 is an outline view showing an example of an electronic apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the embodiments of the present disclosure will be described in detail by referring to the figures. Note that the description will be given in the following order.

1. The first embodiment

Example of a display device in which a cutoff filter is arranged between a light guide panel and a second light source.

2. The second embodiment Example of a display device in which a polarizing panel is arranged between a light guide panel and a second light source.

3. Other embodiments

Configuration example of an electronic apparatus.

### The First Embodiment

### [Overall Configuration of the Display Device]

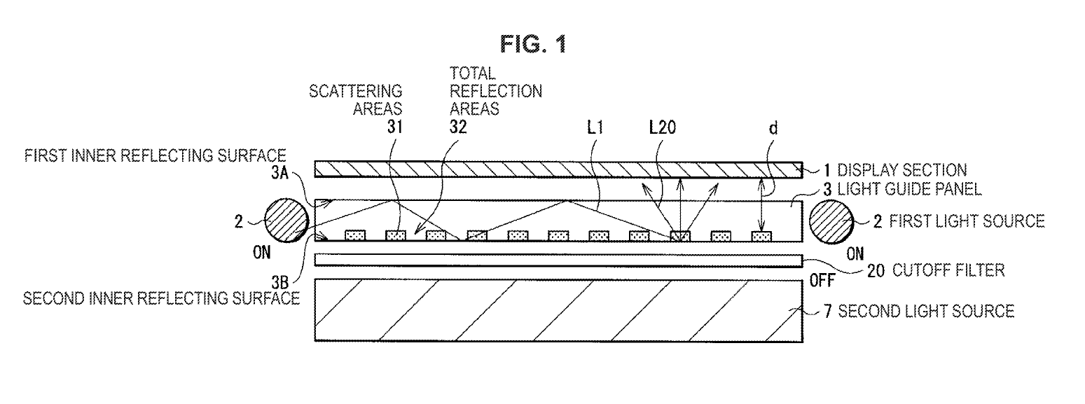

FIGS. 1 to 3 show example configurations of a display device according to the first embodiment of the present disclosure. The display device includes a display section 1 which performs image display, and a light source device which is arranged on a rear side surface of the display section 1 and which irradiates light for image display to the display section 1. The light source device includes a first light source 2 (light source for 2D/3D display), a light guide panel 3, a second light source 7 (light source for 2D display), and a cutoff filter 20. The light guide panel 3 has a first inner reflecting surface 3A which is arranged opposite the side of the display section 1, and a second inner reflecting surface 3B which is arranged opposite the side of the second light source 7. Note that while this display device includes, in addition to this, a control circuit for the display section 1 which may be necessary for display or the like, the configuration is similar to that of a control circuit for a general display, and therefore will be omitted from the following description. Further, while not shown, the light source device includes a control circuit which performs on (lighting) and off (non-lighting) controls of the first light source 2 and the second light source 7.

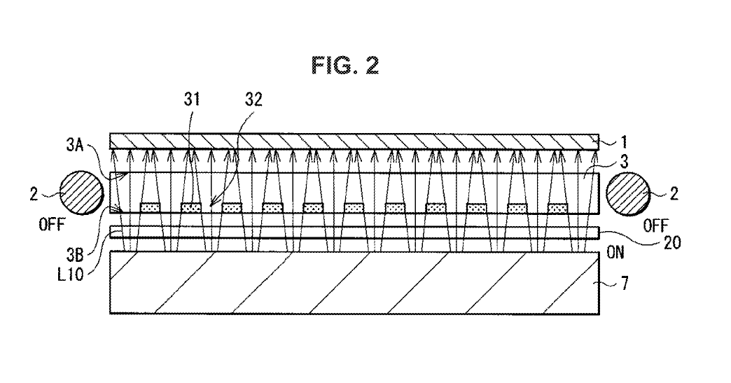

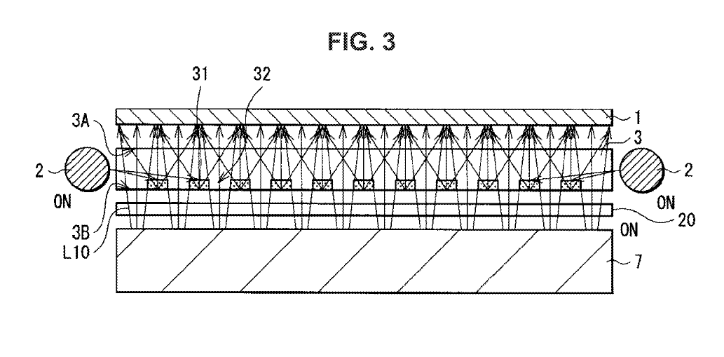

This display device can arbitrary and selectively switch between a two-dimensional (2D) display mode on the entire screen and a three-dimensional (3D) display mode on the entire screen. The switching between the two-dimensional display mode and the three-dimensional display mode can enable a switching control of the image data displayed in the display section 1, and an on/off switching control of the first light source 2 and the second light source 7. FIG. 1 schematically shows an emitting state of a light ray from the light source in the case where only the first light source 2 is in an on (lighting) state, and which corresponds to the three-dimensional mode. FIG. 2 schematically shows an emitting state of a light ray from the light source in the case where only the second light source 7 is in an on (lighting) state, and which corresponds to the two-dimensional mode. Further, FIG. 3 schematically shows an emitting state of a light ray from the light source in the case where both the first light source 2 and the second light source 7 are in an on (lighting) state, and which corresponds to the two-dimensional mode.

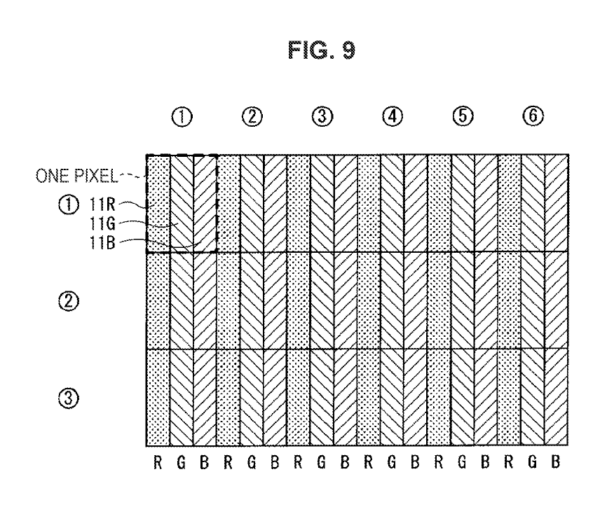

The display section 1 is configured to use a transmission type two-dimensional display panel, for example a transmission type liquid crystal display panel, and as shown in FIG. 9, for example, has a plurality of pixels including pixels 11R for R (red), pixels 11G for G (green) and pixels 11B for B (blue), and this plurality of pixels is arrayed in a matrix. The display section 1 performs two-dimensional image display by modulating the light from the light source device for each pixel in accordance with the image data. A plurality of viewpoint images based on the three-dimensional image data and an image based on the two-dimensional image data are arbitrary and selectively switched and shown in the display section 1. Note that the three-dimensional image data is data which contains, for example, a plurality of viewpoint images corresponding to a plurality of viewing angle directions in the three-dimensional display. For example, in the case where a 2-eye type three-dimensional display is performed, the data is that of viewpoint images for a right eye display and a left eye display. In the case where a display of a three-dimensional display mode is performed, for example, a composite image, in which a plurality of striped viewpoint images are included, is generated and displayed in one screen. Note that a plurality of viewpoint images are allocated to each pixel of the display section 1, and a specific example of the corresponding relation between this allocation pattern and an arrangement pattern of the scattering areas 31 will be described afterwards.

The first light source 2 is configured by using, for example, a fluorescent lamp such as a CCFL (Cold Cathode Fluorescent Lamp) or an LED (Light Emitting Diode). The first light source 2 irradiates first illuminating light L1 (FIG. 1) from a lateral direction to the inside of the light guide panel 3. The first light source 2 is arranged on at least one of the side surfaces of the light guide panel 3. For example, in the case where the planar shape of the light guide panel 3 is a rectangle, there will be four side surfaces, and the first light source 2 may be arranged on at least one of the side surfaces. In FIG. 1, a configuration example is shown in which the first light source 2 is arranged on two opposing side surfaces of the light guide panel 3. The first light source 2 is on (lighting) and off (non-lighting) controlled according to the switching between the two-dimensional display mode and the three-dimensional display mode. Specifically, in the case where an image based on three-dimensional image data is displayed in the display section 1 (in the case of a three-dimensional image mode), the first light source 2 is controlled in a lighting state, and in the case where an image based on two-dimensional image data is displayed in the display section 1 (in the case of a two-dimensional image mode), the first light source 2 is controlled in a non-lighting state or a lighting state.

The second light source 7 is arranged opposite to the side where the second inner reflecting surface 3B is formed in the light guide panel 3. The second light source 7 irradiates second illuminating light L10 from an outside surface to the second inner reflecting surface 3B (refer to FIGS. 2 & 3). The second light source 7 may be a surface light source which radiates light of the same in-plane brightness, and the structure of the second light source 7 itself is not limited to this specific structure, and may use a commercial surface backlight. A structure using a luminous body, such as a CCFL or an LED, a light diffusion panel for uniformizing an in-plane brightness, or the like, can be considered. The second light source 7 is on (lighting) and off (non-lighting) controlled according to the switching between the two-dimensional display mode and the three-dimensional display mode. Specifically, in the case where an image based on the three-dimensional image data is displayed in the display section 1 (in the case of a three-dimensional image mode) the second light source 7 is controlled in a non-lighting state, and in the case where an image based on the two-dimensional image data is displayed in the display section 1 (in the case of a two-dimensional image mode) the second light source 7 is controlled in a lighting state.

The light guide panel 3 is configured, for example, by a transparent plastic panel with acrylic resin or the like. The light guide panel 3 is assumed to be transparent over all surfaces other than the second inner reflecting surface 3B. For example, in the case where the planar shape of the light guide panel 3 is a rectangle, it is assumed that the first inner reflecting surface 3A and the four side surfaces are transparent over their entire surfaces.

The first inner reflecting surface 3A is subject to a mirror surface process over the entire surface, a light ray incident at an angle of incidence satisfying a total reflection condition is totally internally reflected inside the light guide panel 3, and a light ray deviating from the total reflection condition is emitted to the outside.

The second inner reflecting surface 3B has scattering areas 31 and total reflection areas 32. The scattering areas 31, as described later, are formed by a laser process, a sand blasting process, a painting process or by applying a sheet shaped light scattering member to the surface of the light guide panel 3. When the three-dimensional display mode is set, the scattering areas 31 on the second inner reflecting surface 3B function as an opening section (slit section) of a parallax barrier for the first illuminating light L1 from the first light source 2, and the total reflection areas 32 function as a shielding section. The scattering areas 31 and the total reflection areas 32 on the second inner reflecting surface 3B are created by a pattern which becomes a structure corresponding to a parallax barrier. That is, the total reflection areas 32 are created by a pattern corresponding to a shielding section in a parallax barrier, and the scattering areas 31 are created by a pattern corresponding to an opening section in a parallax barrier. Note that various types of objects, such as a striped pattern where a longitudinal slit type opening section is arranged in many horizontal directions or in parallel through a shielding section, can be used as a barrier pattern of a parallax barrier, for example, and these objects are not particularly limited.

The total reflection areas 32 on the first inner reflecting surface 3A and the second inner reflecting surface 3B totally internally reflect light rays irradiated at an angle of incidence θ1 satisfying a total reflection condition, (totally internally reflects light rays incident at an angle of incidence θ1 larger than a prescribed critical angle α). In this way, the first illuminating light L1, from the first light source 2 and incident at an angle of incidence θ1 satisfying a total reflection condition, is optically guided to a lateral direction by total internal reflection between the first inner reflecting surface 3A and the total reflection areas 32 on the second internal reflecting surface 3B. The total reflection areas 32, as shown in FIG. 2 or FIG. 3, further transmit the second illuminating light L10 from the second light source 7, and emit the second illumination light L10 as a light ray deviating from the total reflection condition to the first inner reflecting surface 3A.

Note that the critical angle α for a refractive index of the light guide panel 3 assumed to be n1 and a refractive index of a medium (air layer) outside of the light guide panel 3 assumed to be n0 (<n1) are represented as follows. α and θ1 are assumed to be angles with respect to the normal of the light guide panel surface. The angle of incidence θ1 satisfying a total reflection condition becomes θ1>α.

Sin α=n0/n1.

The scattering areas 31, as shown in FIG. 1, scatter and reflect the first illuminating light L1 from the first light source 2, and emit at least a part of the first illuminating light L1 as a light ray deviating from the total reflection condition (scattering light ray L20) to the first inner reflecting surface 3A.

The cutoff filter 20 is provided between the second inner reflecting surface 3B of the light guide panel 3 and the second light source 4. The cutoff filter 20 is an optical member which reduces the intensity of incident light.

### [Operation and Specific Configuration Example of the Cutoff Filter 20]

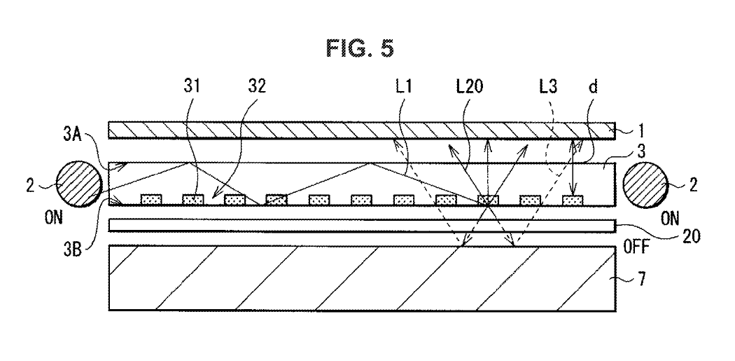

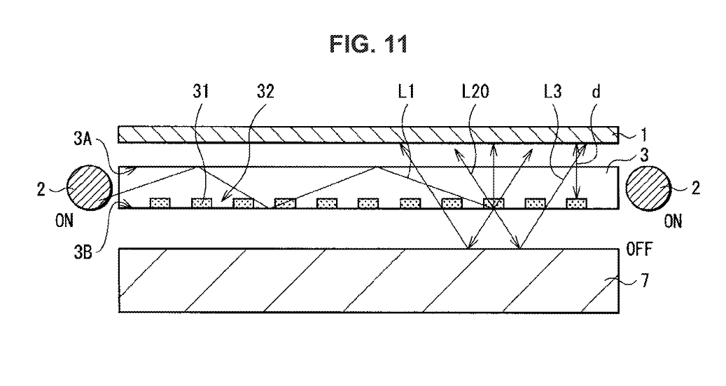

The operation of the cutoff filter 20 will be described by referring to the comparative examples of FIGS. 5 and 11. In the case where the cutoff filter 20 is not provided, such as in the comparative example of FIG. 11, the light of one part of the first illuminating light L1 in the light guide panel 3 becomes light transmitted through the scattering areas 31, becomes light returning to the light guide panel 3 by reflection at the surface of the second light source 4, and is emitted from the light guide panel 3 to the outside as unintentionally emitted light L3. Such unintentionally emitted light L3, in the case where a three-dimensional display is performed, is recognized as mixing the image for the left eye and the image for the right eye, the so-called generation of crosstalk. On the other hand, in the case where the cutoff filter 20 is provided, as shown in FIG. 5, the first illuminating light L1 transmitted through the scattering areas 31 passes through the cutoff filter 20 at least two times by becoming light returning to the light guide panel 3. In this way, the generation of crosstalk can be reduced by substantially reducing the intensity of light returning to the light guide panel 3.

In the case of a three-dimensional mode, the more the transmittance of the cutoff filter 20 decreases, the more the generation of crosstalk by the above-mentioned unintentionally emitted light L3 can be reduced. On the other hand, in the case of a two-dimensional mode, since the intensity of the second illuminating light L10 from the second light source 7 is reduced by the cutoff filter 20, a reduction of the utilization efficiency of light is caused in the two-dimensional display. Therefore, it is preferable to use an object which is appropriate in consideration of the display characteristics of two-dimensional and three-dimensional displays, and an object in which the transmittance is suitable, as the cutoff filter 20. Further, the cutoff filter 20 may preferably have a transmittance which is almost constant in a visible light ray region. When the transmittance by wavelength differs greatly, spectrum components by light from the first light source 2 and the second light source 7 differ greatly at stages emitted from the light guide panel 3, and colors differing between the two-dimensional display and the three-dimensional display are observed. By considering such conditions, it is preferable to use an ND (Neutral Density) filter as the cutoff filter 20. Further, a colored acrylic panel, for example, may be used. Further, in place of the cutoff filter 20, an element of variable transmittance, for example a liquid crystal display panel, may be used. In this case, the transmittance may be controlled so that the transmittance becomes relatively high in the case of the two-dimensional mode, and the transmittance becomes relatively low in the case of the three-dimensional mode.

### [Modified Example of the Configuration of the Display Device]

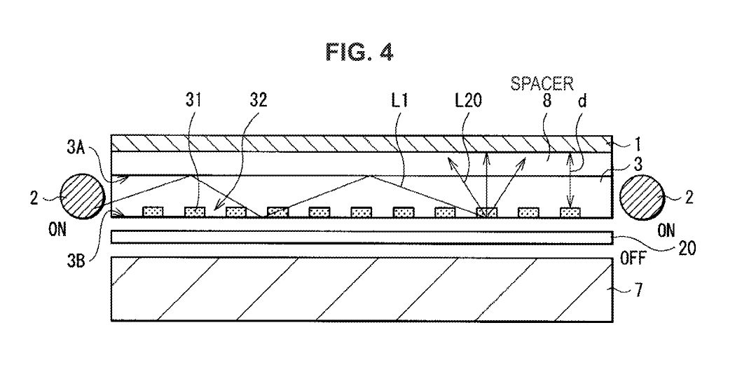

In the display device shown in FIG. 1, a pixel section of the display section 1 and the scattered areas 31 of the light guide panel 3 may have to be arranged opposite each other to maintain a prescribed distance d, so that a space separation of the plurality of viewpoint images shown in the display section 1 is performed. While in FIG. 1 the space between the display section 1 and the light guide panel 3 is an air gap, as shown in the first modified example of FIG. 4, a spacer 8 may be arranged between the display section 1 and the light guide panel 3 for maintaining the prescribed distance d. The spacer 8 may use a transparent and colorless material that reduces scattering, for example PMMA or the like. This spacer 8 may be provided so that it entirely covers the rear side surface of the display section 1 and the surfaces of the light guide panel 3, and the spacer 8 may be provided partially with a minimum requirement for maintaining the distance d.

Further, the air gap may be reduced by increasing the entire thickness of the light guide panel 3.

### [Specific Configuration Example of the Scattering Areas 31]

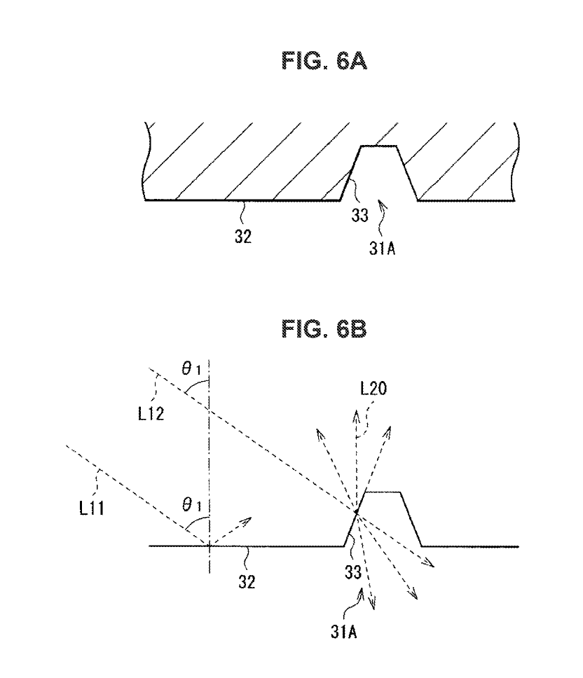

FIG. 6A shows a first configuration example of the second inner reflecting surface 3B in the light guide panel 3. FIG. 6B schematically shows a reflecting state and a scattering state of a light ray at the second inner reflecting surface 3B in the first configuration example shown in FIG. 6A. This first configuration example is a configuration example in which the scattering areas 31 are assumed to be recessed scattering areas 31A for total reflection areas 32. Such recessed scattering areas 31A can be formed, for example, by a sand blasting process or a laser process. For example, after a surface of the light guide panel 3 has been mirror surface processed, the parts corresponding to the scattering areas 31A can be formed by a laser process. In the case of this first configuration example, the first illuminating light L11, from the first light source 2 and incident at an angle of incidence θ1 satisfying a total reflection condition, is totally internally reflected at the total reflection areas 32 on the second inner reflecting surface 3B. On the other hand, even if light is incident at an angle of incidence θ1 identical to that of the total reflection areas 32 in the recessed scattering areas 31A, a part of the light ray of the incident first illuminating light L12 will not satisfy a total reflection condition at a recessed side surface part 33, the part of the light ray will be scattered and transmitted, and the rest will be scattered and reflected. A part or the entire scattered and reflected light ray (scattering light ray L20), as shown in FIG. 1, is emitted as a light ray deviating from a total reflection condition to the first inner reflecting surface 3A.

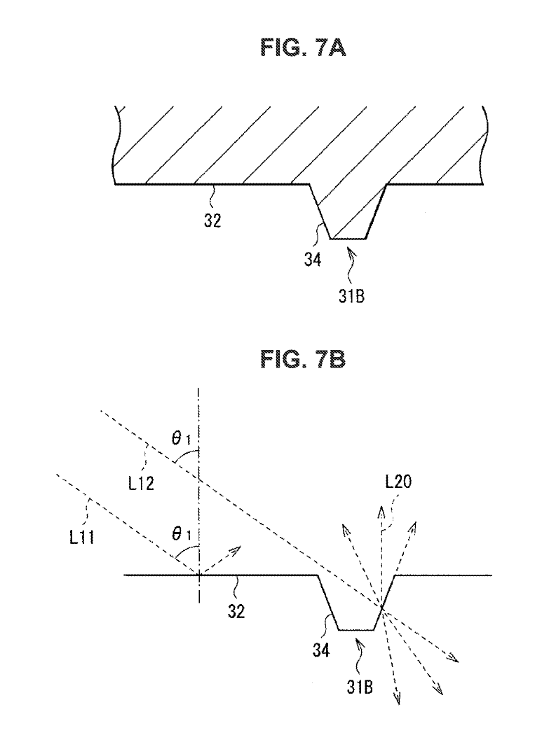

FIG. 7A shows a second configuration example of the second inner reflecting surface 3B in the light guide panel 3. FIG. 7B schematically shows a reflecting state and a scattering state of a light ray at the second inner reflecting surface 3B in the second configuration example shown in FIG. 7A. This second configuration example is a configuration example in which the scattering areas 31 are assumed to be projected scattering areas 31B for the total reflection areas 32. Such projected scattering areas 31B can be formed, for example, by mold processing the surface of the light guide panel 3 with a metal mold. In this case, a mirror surface process is performed for the parts corresponding to the total reflection areas 32 with the surface of the metal mold. In the case of this second configuration example, the first illuminating light L11, from the first light source 2 and incident at an angle of incidence θ1 satisfying a total reflection condition, is totally internally reflected by the total reflection areas 32 on the second inner reflecting surface 3B. On the other hand, even if light is incident at an angle of incidence θ1 identical to that for the total reflection areas 32 in the projected scattering areas 31B, a part of the light ray of the incident first illuminating light L12 will not satisfy a total reflection condition at a projected side surface part 34, the part of the light ray will be scattered and transmitted, and the rest will be scattered and reflected. A part or the entire scattered and reflected light ray (scattering light ray L20), as shown in FIG. 1, is emitted as a light ray deviating from a total reflection condition to the first inner reflecting surface 3A.

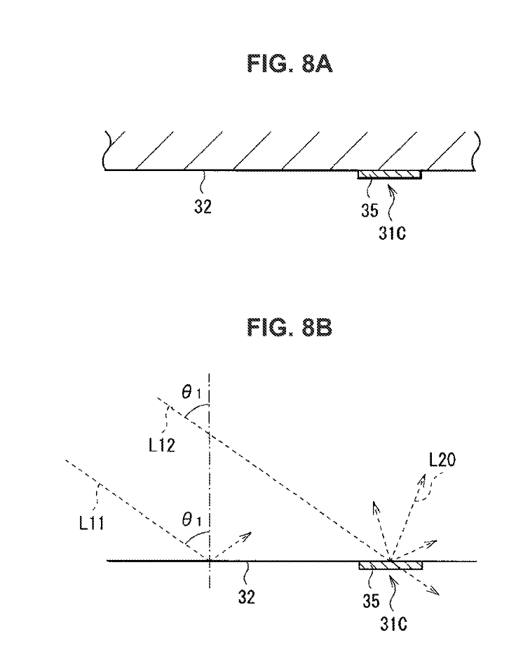

FIG. 8A shows a third configuration example of the second inner reflecting surface 3B in the light guide panel 3. FIG. 8B schematically shows a reflecting state and a scattering state of a light ray at the second inner reflecting surface 3B in the third configuration example shown in FIG. 8A. In the configuration examples of FIGS. 6A and 7A, the scattering areas 31 were formed by a surface process in a shape different than those of the total reflection areas 32 of the surface of the light guide panel 3. On the other hand, the scattering areas 31C according to the configuration example of FIG. 8A have arranged, without a surface process, an optical member 35 with a material different to that of the light guide panel 3, on the surface of the light guide panel 3 corresponding to the second inner reflecting surface 3B. In this case, the scattering areas 31C can be formed by patterning a surface of the light guide panel 3 by screen printing a white coating (for example, barium sulfate), for example, as the optical member 35. In the case of this third configuration example, the first illuminating light L11, from the first light source 2 and incident at an angle of incidence θ1 satisfying a total reflection condition, is totally internally reflected by the total reflection areas 32 on the second inner reflecting surface 3B. On the other hand, even if light is incident at an angle of incidence θ1 identical to that to the total reflection areas 32 in the scattering areas 31C in which the optical member 35 is arranged, a part of the light ray of the incident first illuminating light L12 is scattered and transmitted by the optical member 35, and the remainder is scattered and reflected. A part or the entire scattered and reflected light ray is emitted as a light ray deviating from a total reflection condition to the first inner reflecting surface 3A.

The configuration examples are not limited to those included above, and other configuration examples can be considered for the configuration of the scattering areas 31. For example, the parts corresponding to the scattering areas 31 on the surface of the light guide panel 3 can be formed by methods such as a sand blast process, coating, or the like. Further, while the cross-sectional shape of the scattering areas 31 (scattering areas 31A, 31B) is shown as a trapezoid example in FIGS. 6A and 7A, the cross-sectional shape is not limited to the case of a trapezoid, and can use a various types, such as a semicircle or a polygon.

### [Basic Operation of the Display Device]

In the case where display is performed by a three-dimensional display mode in this display device, image display based on the three-dimensional image data is performed in the display section 1, and the first light source 2 and the second light source 7 are on (lighting) and off (non-lighting) controlled for three-dimensional display. Specifically, as shown in FIG. 1, the first light source 2 is controlled in an on (lighting) state, and the second light source 7 is controlled in an off (non-lighting) state. In this condition, the first illuminating light L1 from the first light source 2 is optically guided from one side surface where the first light source 2 is arranged to the opposite other side surface, by repeating the total internal reflection between the first inner reflecting surface 3A and total reflection areas 32 of the second inner reflecting surface 3B in the light guide panel 3, and is emitted from the other side surface. On the other hand, the part of the first illuminating light L1 from the first light source 2 is transmitted through the first inner reflecting surface 3A of the light guide panel 3 by scattering and reflecting at the scattering areas 31 of the light guide panel 3, and is emitted to outside of the light guide panel 3. In this way, the function of a parallax barrier can be provided in the light guide panel itself. That is, the scattering areas 31 can equivalently function as an opening section (slit section) and the total reflection areas 32 can equivalently function as a parallax barrier having a shield section, for the first illuminating light L1 from the first light source 2. In this way, three-dimensional display can be equivalently performed by a parallax barrier method where a parallax barrier is arranged on a rear surface side of the display section 1.

In the case where such a three-dimensional display is performed, it can be considered that the first illuminating light L1 is transmitted through the scattering areas 31, and in the case where the first illuminating light L1 is reflected at the surface of the second light source 7, the first illuminating light L1 is emitted to outside of the light guide panel 3 as unintentionally emitted light L3. According to this embodiment of the present disclosure, this unintentionally emitted light L3 is reduced by providing a cutoff filter 20, which reduces the intensity of incident light, between the light guide panel 3 and the second light source 7, as shown in FIG. 5. In this way, the generation of crosstalk by the unintentionally emitted light L3 can be reduced.

On the other hand, in the case where display is performed in a two-dimensional display mode, an image display based on two-dimensional image data is performed in the display section 1, and the first light source 2 and the second light source 7 are on (lighting) and off (non-lighting) controlled for two-dimensional display. Specifically, as shown in FIG. 2, the first light source 2 is controlled in an off (non-lighting) state, and the second light source 7 is controlled in an on (lighting) state. In this case, the second illuminating light L10 from the second light source 7 is emitted from almost the entire surface of the first inner reflecting surface 3A by transmitting through the total reflection areas 32 on the second inner reflecting surface 3B to outside of the light guide panel 3, by a light ray deviating from the total reflection condition. That is, the light guide panel 3 functions as a surface light source similar to a normal backlight. In this way, two-dimensional display can be equivalently performed by a backlight method where a normal backlight is arranged on the rear surface of the display section 1.

Note that while the second illuminating light 10 is emitted from almost all surfaces of the light guide panel 3 even if only the second light source 7 is lit, if necessary, the first light source 2 may also be lit, as shown in FIG. 3. In this way, for example, by lighting only the second light source 7 in such a case where a difference in brightness distribution is generated by the parts corresponding to the scattering areas 31 and the total reflection areas 32, it is possible to optimize the brightness distribution over all the surfaces by suitably adjusting the lighting function of the first light source 2 (on and off controlling or adjusting the lighting amount). However, in the case where two-dimensional display is performed, and in the case where sufficient brightness correction is performed on the display section 1 side, for example, there is no problem with lighting from only the second light source 7.

### [Corresponding Relation Between an Allocation Pattern of a Viewpoint Image and an Arrangement Pattern of the Scattering Areas 31]

In the case where display is performed by a three-dimensional display mode in this display device, a plurality of viewpoint images are shown in the display section 1 by allocating a prescribed allocation pattern to each pixel. The plurality of scattering areas 31 in the light guide panel 3 are provided with a prescribed arrangement pattern corresponding to this prescribed allocation pattern.

Hereinafter, a specific example of the corresponding relation between the allocation pattern of the viewpoint images and the arrangement pattern of the scattering areas 31 will be described. As shown in FIG. 9, the pixel structure of the display section 1 has a plurality of pixels which includes pixels 11R for R (red), pixels 11G for G (green) and pixels 11B for B (blue), and this plurality of pixels is arrayed in a matrix in a first direction (vertical direction) and in a second direction (horizontal direction). Each pixel of the three colors 11R, 11G and 11B is periodically and alternately arrayed in a horizontal direction, and each pixel of the three colors 11R, 11G and 11B is arrayed in a vertical direction. In the case of this pixel structure, in a state which displays a normal two-dimensional image (two-dimensional display mode) in the display section 1, a horizontally consecutive combination of each pixel of the three colors 11R, 11G and 11B becomes one pixel (one unit pixel of a 2D color display) for performing two-dimensional color display. FIG. 9 shows one unit pixel of a 2D color display for 6 pixel parts in a horizontal direction and 3 pixel parts in a vertical direction.

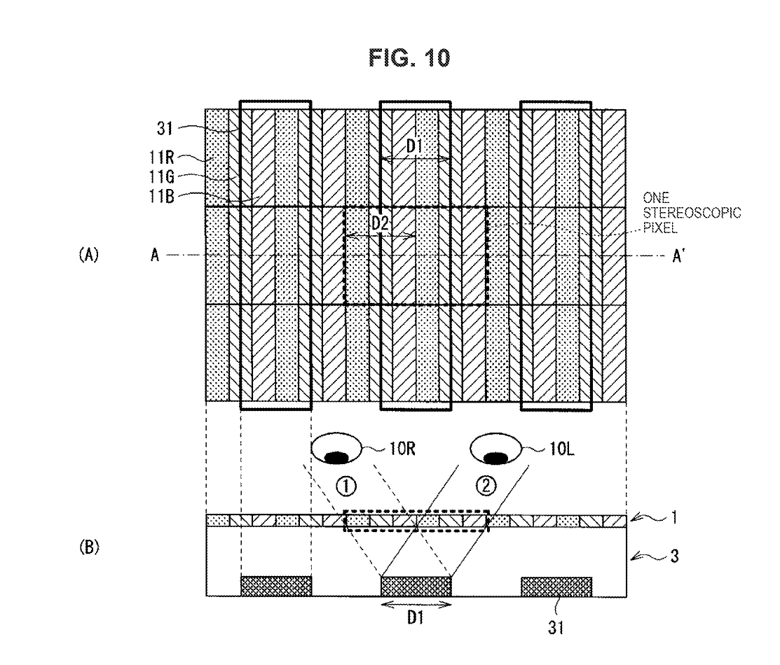

FIG. 10 shows an example of a corresponding relation between the allocation pattern and the arrangement pattern of the scattering areas 31 in the pixel structure of FIG. 9, in the case where two viewpoint images (first and second viewpoint images) are allocated to each pixel of the display section 1. FIG. 10(B) is equivalent to a section of the part A-A′ of FIG. 10(A). FIG. 10(B) schematically shows a separation condition of two viewpoint images. In this example, one unit pixel of a 2D color display is allocated as one pixel for displaying one viewpoint image. Then, a pixel which horizontally and alternatively shows a first viewpoint image and a second viewpoint image is allocated. Therefore, one unit pixel of the 2D color display is combined into two parts horizontally and becomes one unit pixel (one stereoscopic pixel) of a three-dimensional display. As shown in FIG. 10(B), stereoscopic vision is performed at a state in which the first viewpoint image reaches only an observer's right eye 10R, and the second viewpoint image reaches only an observer's left eye 10L. In this example, the horizontal arrangement position of the scattering areas 31 is arranged so as to be positioned in an approximately central part of one unit pixel of the three-dimensional display.

Here, the width D1 of the horizontal direction of the scattering areas 31 is of a size which has a prescribed relation to the width D2 of one pixel for displaying one viewpoint image. Specifically, the width D1 of the scattering areas 31 are preferably of a size between 0.2 and 1.5 times that of the width D2. The more the width D1 of the scattering areas 31 increases, the more the amount of light scattered by the scattering areas 31 increases, and the more the amount of light emitted from the light guide panel 3 increases. Therefore, brightness can be increased. However, when the width D1 of the scattering areas 31 exceeds 1.5 times that of the width D2, the light from the plurality of viewpoint images is observed to be mixed, that is, cross talk is generated, and is therefore undesirable. Conversely, the more the width D1 of the scattering areas 31 decreases, the more the amount of light scattered by the scattering areas 31 decreases, and the amount of light emitted from the light guide panel 3 decreases. Therefore, the brightness decreases. When the width D1 of the scattering areas 31 falls below 0.2 times that of the width D2, the brightness decreases too much, the image display becomes too dark, and is therefore undesirable.

Note that while the example in FIG. 10 is for the case of two viewpoints, the viewpoint number (the number of displayed viewpoint images) is not limited to two, and may be three or more. Further, the allocation pattern of the viewpoint images and the arrangement pattern of the scattering areas 31 are not limited to the example shown in FIG. 10, and may be other patterns. For example, the allocation pattern may be an allocation pattern which combines a pixel 11R for R (red), a pixel 11G for G (green) and a pixel 11B for B (blue) in a diagonal direction, and allocates these pixels as one pixel for displaying one viewpoint image. In this case, the scattering areas 31 become a pattern arranged inclined in a diagonal direction.

### [Effect]

According to the display device according to the present embodiment as described above, the scattering areas 31 and total reflection areas 32 are provided on the second inner reflecting surface 3B of the light guide panel 3, and since it is possible to selectively emit the first illuminating light L1 from the first light source 2 and the second illuminating light L10 from the second light source 7 to outside of the light guide panel 3, the function of a parallax barrier can be equivalently provided in the light guide panel 3 itself. In this way, the number of parts is reduced in comparison to a stereoscopic display device of a parallax barrier method from the related art, and space savings can be achieved. Further, since a cutoff filter 20 for reducing the intensity of incident light is provided between the light guide panel 3 and the second light source 7, unintentionally emitted light L3, which is emitted from the light guide panel 3 by reflecting on the surface of the second light source 7, can be reduced.

### The Second Embodiment

Next, a display device according to the second embodiment of the present disclosure will be described. Note that the same reference numerals denote substantially the same structural elements of those from the above display device according to the first embodiment, and the description of them will be suitably omitted.

### [Overall Configuration of the Display Device]

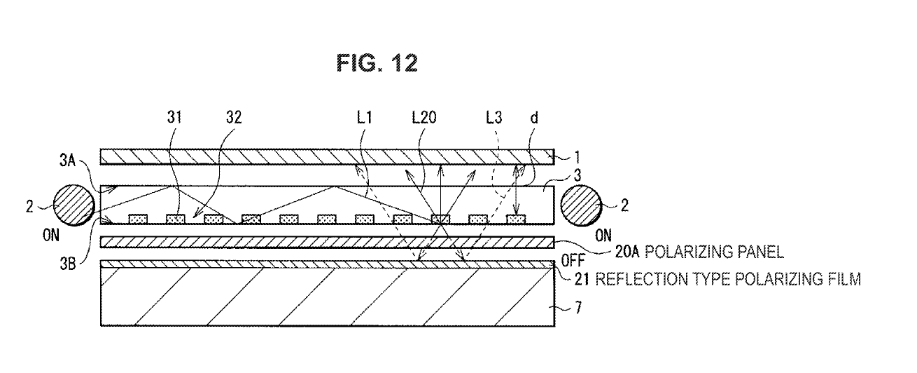

FIG. 12 shows a configuration example of the display device according to the second embodiment with an emitting state of a light ray from a light source device, in the case where only the first light source 2 is in an on (lighting) state. The display device according to the present embodiment includes a polarizing panel 20A as the optical member, in place of the cutoff filter 20 in the above display device according to the first embodiment. Further, a reflection type polarizing film 21 is included, which is arranged between the second light source 7 and the polarizing panel 20A. Other components are similar to those of the above display device according to the first embodiment.

The reflection type polarizing film 21 is a brightness enhancement member which emits by only increasing a prescribed polarizing component. For example, DBEF (Dual Brightness Enhancement Film) of Sumitomo 3M Ltd. can be used as the reflection type polarizing film 21. DBEF improves the utilization factor of light by transmitting a P polarizing component, from within the incident light, and converting by reflection an S polarizing component so that it becomes a P polarizing component. The transmission axis of the light of the polarizing panel 20A and the reflection type polarizing film 21 are assumed to be the same so as to improve the utilization factor of light. In the case where the display section 1 is a liquid crystal display panel, the transmission axis of the polarizing panel 20A and the rear surface side are assumed to be the same.

### [Operation of the Polarizing Panel 20A]

In the case where the polarizing panel 20A is not provided, such as in the comparative example of FIG. 11, the light of one part of the first illuminating light L1 in the light guide panel 3 becomes light transmitted through the scattering areas 31, becomes light returning to the light guide panel 3 by reflection at the surface of the second light source 4, and is emitted from the light guide panel 3 to the outside as unintentionally emitted light L3. Such unintentionally emitted light L3, in the case where a three-dimensional display is performed, is recognized as mixing the image for the left eye and the image for the right eye, the so-called generation of crosstalk. On the other hand, in the case where the polarizing panel 20A is provided, as shown in FIG. 12, the first illuminating light L1 transmitted through the scattering areas 31 passes through the polarizing panel 20A at least two times by becoming light returning to the light guide panel 3. In this way, the generation of crosstalk can be reduced by substantially reducing the intensity of light returning to the light guide panel 3.

In this way, the generation of crosstalk can be reduced in the case where three-dimensional display is performed, similar to that of the above cutoff filter 20 in the first embodiment, by providing the polarizing panel 20A.

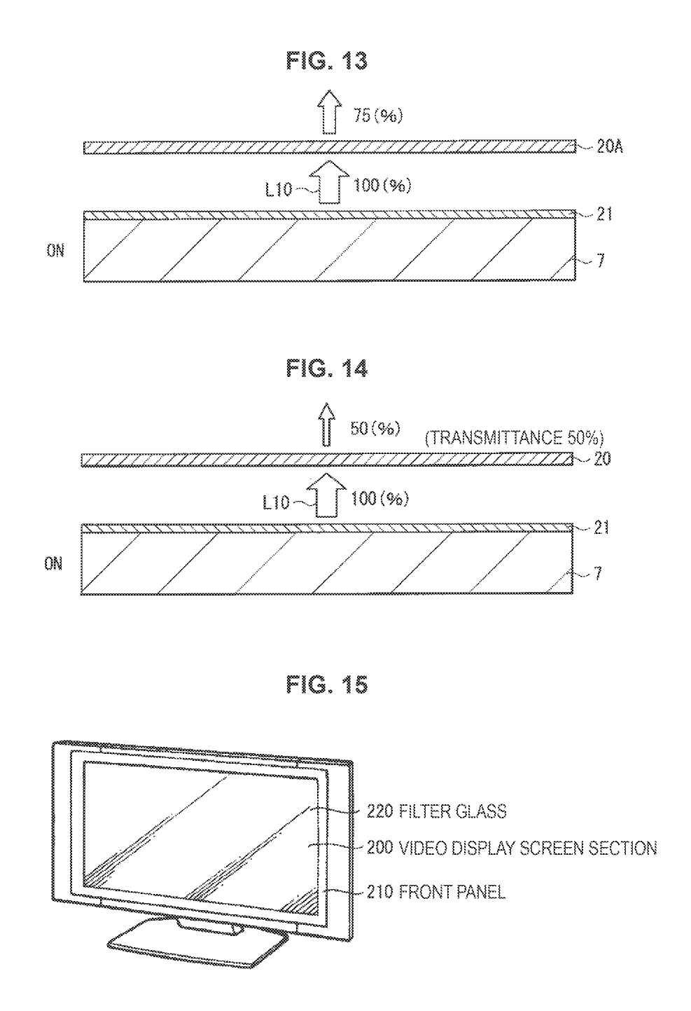

In addition, in the present embodiment the utilization factor of light (utilization factor of light from the second light source 7), in the case of performing two-dimensional display, can be improved in comparison to the case where the cutoff filter 20 is used. FIG. 13 shows an example of a transmission state of the second illuminating light L10 from the second light source 7, in the case where the polarizing panel 20A is used as the optical member. FIG. 14 shows an example of a transmission state of the second illuminating light L10, in the case where the cutoff filter 20 is used as the optical member. Here, the rate (brightness) of the second illuminating light L10 immediately before being incident on the polarizing panel 20A or the cutoff filter 20 is assumed to be 100%. The light transmittance of the cutoff filter 20 is assumed to be 50%. In the examples of FIG. 13 and FIG. 14, in the case where the polarizing panel 20A is used, the utilization factor of the second illuminating light L10 improves 1.5 times. In the case where the cutoff filter 20 is used, the intensity decreases, regardless of the polarizing component. In this way, in the case where the polarizing panel 20A is used, since only the prescribed polarizing component will be reduced, the reduction of intensity for the second illuminating light L10 can be further reduced.

Note that a separate member may be arranged between the polarizing panel 20A and the reflection type polarizing film 21. For example, the polarizing panel 20A and the reflection type polarizing film 21 may be stuck together through an adhesive.

### Other Embodiments

It should be understood by those skilled in the art that various modifications, combinations, sub-combinations and alterations may occur depending on design requirements and other factors insofar as they are within the scope of the appended claims or the equivalents thereof.

For example, it is possible to use various electronic apparatuses having a display function for any of the above display devices according to the embodiments. FIG. 15 shows an outline view of a television system as an example of such an electronic apparatus. This television system includes a video display screen section 200 which has a front panel 210 and a filter glass 220.

The present technology may also be configured as below, for example.
(1) A light source device including:

a light guide panel which has a first inner reflecting surface and a second inner reflecting surface opposing each other;

a first light source which irradiates first illuminating light from a lateral direction to the light guide panel;

a second light source which is arranged opposite a side on which the second inner reflecting surface is formed on the light guiding panel, and which irradiates second illuminating light to the second inner reflecting surface; and

an optical member which is arranged between the light guide panel and the second light source, and which reduces intensity of incident light;

wherein a plurality of scattering areas are provided on the second inner reflecting surface which scatter and emit the first illuminating light from the first inner reflecting surface to outside of the light guide panel.
(2) The light source device according to (1),

wherein the optical member is a polarizing panel.
(3) The light source device according to (1) or (2), further including:

a brightness enhancement member which is arranged between the optical member and the second light source, and which emits by only increasing a prescribed polarizing component.
(4) The light source device according to any one of (1) to (3),

wherein total reflection areas are provided at parts other than the plurality of scattering areas on the second inner reflecting surface, and which totally internally reflect the first illuminating light and transmit the second illuminating light.
(5) The light source device according to (4),

wherein the scattering areas are formed into shapes different from those of the total reflection areas by a surface process on a surface of the light guide panel corresponding to the second inner reflecting surface.
(6) The light source device according to (4),

wherein the scattering areas are formed by arranging a light scattering member made of a material different from that of the light guide panel on the surface of the light guide panel corresponding to the second inner reflecting surface.
(7) A display device, including:

a display section which performs image display; and

a light source device which emits light for the image display to the display section;

wherein the light source device has

a light guide panel which has a first inner reflecting surface and a second inner reflecting surface opposing each other;

a first light source which irradiates first illuminating light from a lateral direction to the light guide panel;

a second light source which is arranged opposite a side on which the second inner reflecting surface is formed on the light guiding panel, and which irradiates second illuminating light to the second inner reflecting surface; and

an optical member which is arranged between the light guide panel and the second light source, and which reduces intensity of incident light; and

wherein a plurality of scattering areas are provided on the second inner reflecting surface which scatter and emit the first illuminating light from the first inner reflecting surface to outside of the light guide panel.
(8) The display device according to (7),

wherein the display section displays by selectively switching between a plurality of viewpoint images based on three-dimensional image data and an image based on two-dimensional image data; and

wherein in a case where the plurality of viewpoint images are displayed in the display section, the second light source is controlled in a non-lighting state, and in a case where the image based on two-dimensional image data is displayed in the display section, the second light source is controlled in a lighting state.
(9) The display device according to (8),

wherein in a case where the plurality of viewpoint images are displayed in the display section, the first light source is controlled in a lighting state, and in a case where the image based on two-dimensional image data is displayed in the display section, the first light source is controlled in a non-lighting state or the lighting state.
(10) An electronic apparatus, including:

a display apparatus, including

a display section which performs image display; and

a light source device which emits light for the image display to the display section;

wherein the light source device has

a light guide panel having a first inner reflecting surface and a second inner reflecting surface opposing each other;

a first light source which irradiates first illuminating light from a lateral direction to the light guide panel;

a second light source which is arranged opposite a side on which the second inner reflecting surface is formed on the light guiding panel, and which irradiates second illuminating light to the second inner reflecting surface; and

an optical member which is arranged between the light guide panel and the second light source, and which reduces intensity of incident light; and

wherein a plurality of scattering areas are provided on the second inner reflecting surface which scatter and emit the first illuminating light from the first inner reflecting surface to outside of the light guide panel.

The present disclosure contains subject matter related to that disclosed in Japanese Priority Patent Applications JP 2011-211922 and JP 2011-246774 filed in the Japan Patent Office on Sep. 28, 2011 and Nov. 10, 2011, respectively, the entire content of which is hereby incorporated by reference.

What is claimed is:

1. A light source device comprising:
a light guide panel which has a first inner reflecting surface and a second inner reflecting surface opposing each other;
a first light source which irradiates first illuminating light from a lateral direction to the light guide panel;
a second light source which is arranged opposite a side on which the second inner reflecting surface is formed on the light guiding panel, and which irradiates second illuminating light to the second inner reflecting surface; and
an optical member which is arranged between the light guide panel and the second light source, and which reduces intensity of incident light;
wherein a plurality of scattering areas are provided on the second inner reflecting surface which scatter and emit the first illuminating light from the first inner reflecting surface to outside of the light guide panel.

2. The light source device according to claim 1,
wherein the optical member is a polarizing panel.

3. The light source device according to claim 1, further comprising:
a brightness enhancement member which is arranged between the optical member and the second light source, and which emits by only increasing a prescribed polarizing component.

4. The light source device according to claim 1,
wherein total reflection areas are provided at parts other than the plurality of scattering areas on the second inner reflecting surface, and which totally internally reflect the first illuminating light and transmit the second illuminating light.

5. The light source device according to claim 4,
wherein the scattering areas are formed into shapes different from those of the total reflection areas by a surface process on a surface of the light guide panel corresponding to the second inner reflecting surface.

6. The light source device according to claim 4,
wherein the scattering areas are formed by arranging a light scattering member made of a material different from that of the light guide panel on the surface of the light guide panel corresponding to the second inner reflecting surface.

7. A display device, comprising:
a display section which performs image display; and
a light source device which emits light for the image display to the display section;
wherein the light source device has
a light guide panel which has a first inner reflecting surface and a second inner reflecting surface opposing each other;
a first light source which irradiates first illuminating light from a lateral direction to the light guide panel;
a second light source which is arranged opposite a side on which the second inner reflecting surface is formed on the light guiding panel, and which irradiates second illuminating light to the second inner reflecting surface; and
an optical member which is arranged between the light guide panel and the second light source, and which reduces intensity of incident light; and
wherein a plurality of scattering areas are provided on the second inner reflecting surface which scatter and emit the first illuminating light from the first inner reflecting surface to outside of the light guide panel.

8. The display device according to claim 7,
wherein the display section displays by selectively switching between a plurality of viewpoint images based on three-dimensional image data and an image based on two-dimensional image data; and
wherein in a case where the plurality of viewpoint images are displayed in the display section, the second light source is controlled in a non-lighting state, and in a case where the image based on two-dimensional image data is displayed in the display section, the second light source is controlled in a lighting state.

9. The display device according to claim 8,
wherein in a case where the plurality of viewpoint images are displayed in the display section, the first light source is controlled in a lighting state, and in a case where the image based on two-dimensional image data is displayed in the display section, the first light source is controlled in a non-lighting state or the lighting state.

10. An electronic apparatus, comprising:
a display apparatus, including
a display section which performs image display; and
a light source device which emits light for the image display to the display section;
wherein the light source device has
a light guide panel having a first inner reflecting surface and a second inner reflecting surface opposing each other;
a first light source which irradiates first illuminating light from a lateral direction to the light guide panel;
a second light source which is arranged opposite a side on which the second inner reflecting surface is formed on the light guiding panel, and which irradiates second illuminating light to the second inner reflecting surface; and
an optical member which is arranged between the light guide panel and the second light source, and which reduces intensity of incident light; and
wherein a plurality of scattering areas are provided on the second inner reflecting surface which scatter and emit the first illuminating light from the first inner reflecting surface to outside of the light guide panel.
